(19) United States
(12) Patent Application Publication
(10) Pub. No.: US 2016/0154867 A1
(43) Pub. Date: Jun. 2, 2016

(54) Data Stream Processing Using a Distributed Cache

(71) Applicant: HEWLETT PACKARD ENTERPRISE DEVELOPMENT LP, Houston, TX (US)

(72) Inventors: Qiming Chen, Cupertino, CA (US); Meichun Hsu, Los Altos Hills, CA (US)

(21) Appl. No.: 14/906,003

(22) PCT Filed: Jul. 31, 2013
(86) PCT No.: PCT/US13/53012

§ 371 Date: Jan. 19, 2016

(51) Int. Cl. G06F 17/30; G06F 9/48; G06F 12/08

(52) U.S. Cl. CPC G06F 17/30569; G06F 12/0813; G06F 17/30876; G06F 17/30516; G06F 9/4881; G06F 2212/603

(57) ABSTRACT

A method for processing a data stream may comprise retrieving a first window from a distributed cache platform based on a first window key, executing a first task and a second task in parallel on a processor resource, and merging a first result and a second result into a stream result based on a relationship between a first task key and a second task key.

### BACKGROUND

A computer may have a processor, or be part of a network of computers, capable of processing data and/or instructions in parallel or otherwise concurrently with other operations. Parallel processing capabilities may be based on the level of parallelization, such as processing at the data-level, instruction-level, and/or task-level. A computation may be processed in parallel when the computation is independent of other computations or may be processed sequentially when the computation is dependent on another computation. For example, instruction-level parallel processing may determine instructions that are independent of one another and designate those instructions to be processed in parallel.

### BRIEF DESCRIPTION OF THE DRAWINGS

FIG. 1 depicts an example environment in which various examples for processing a data stream may be implemented.

FIGS. 2 and 3 are flow diagrams depicting example methods for processing a data stream.

FIG. 4 depicts example operations for processing a data stream.

FIGS. 5 and 6 are block diagrams depicting example systems for processing a data stream.

### DETAILED DESCRIPTION

### Introduction

In the following description and figures, some example implementations of systems and/or methods for processing a data stream are described. A data stream may include a sequence of digitally encoded signals. The data stream may be part of a transmission, an electronic file, or a set of transmissions and/or files. For example, a data stream may be a sequence of data packets or a word document containing strings or characters, such as a deoxyribonucleic acid (“DNA”) sequence.

Stream processing may perform a series of operations on portions of a set of data from a data stream. Stream processing may commonly deal with sequential pattern analysis and may be sensitive to order and/or history associated with the data stream. Stream processing with such sensitivities may be difficult to parallelize.

A sliding window technique of stream processing may designate a portion of the set of data of the data stream as a window and may perform an operation on the window of data as the boundaries of the window move along the data stream. The window may “slide” along the data stream to cover a second set of boundaries of the data stream, and, thereby, cover a second set of data. Stream processing may apply an analysis operation on each window of the data stream. Many stream processing applications based on a sliding window technique may utilize sequential pattern analysis and may perform history-sensitive analytical operations. For example, an operation on a window of data may depend on a result of an operation of a previous window.

One form of parallelization may use a split-and-merge theme. Under a split-and-merge theme, a split operation may distribute content to multiple computation operations running in parallel and a merge operation may merge the results. A window may commonly be made of multiple data chunks, or portions of the data of the data stream. Sequential windows may have overlapping data chunks. Sequential pattern analysis may be performed on each window. Applying a split-and-merge theme to sequential pattern analysis, the split operation may provide copies of a window for each task, and therefore, multiple copies of data chunks may be generated because sequential windows may have overlapping data chunks. The window generator may be overloaded with high throughput when processing windows that have overlapping content.

However, by utilizing a distributed cache platform, the processing system may split the data, place the data in a medium that is commonly accessible, operate on the data from the medium, and merge the task results. The distributed cache platform may provide a unified access protocol to a distributed cache and may allow parallelized operations to access the distributed cache. The individual tasks performed on each sliding window may be performed in parallel by managing access to the data stream (and more particularly, the data chunks) through the distributed cache platform and managing the order of merging the results of the operations. The distributed cache platform may allow the copy operation to be offloaded (or removed entirely) from the split operation by using references to the distributed cache rather than generating copies of data chunks for each task. As the split operation may commonly divide and copy the window data, stream processing speed and/or system performance may be improved by offloading the copy operation and performing the operations, or tasks, in parallel.

The following description is broken into sections. The first, labeled “Environment,” describes examples of computer and network environments in which various examples for processing a data stream may be implemented. The second section, labeled “Operation,” describes example methods to implement various examples for processing a data stream. The third, labeled “Components,” describes examples of physical and logical components for implementing various examples.

Environment:

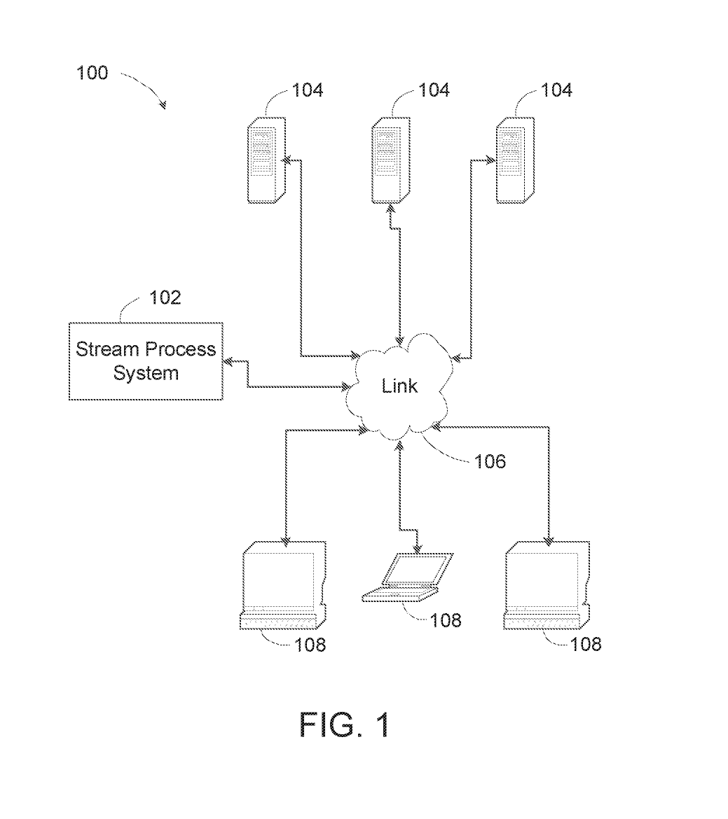

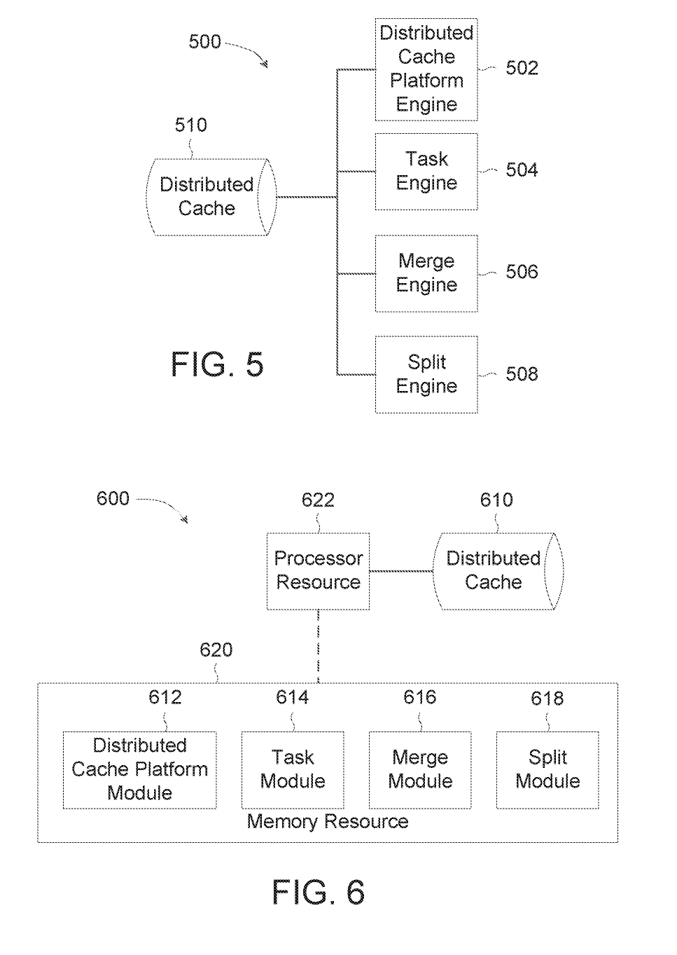

FIG. 1 depicts an example environment 100 in which various examples may be implemented. The environment 100 is shown to include a stream process system 102. The stream process system 102 described below with respect to FIGS. 5 and 6, may represent generally any combination of hardware and programming configured to process a data stream. The stream process system 102 may be integrated into a server device 104 or a client device 108. The stream process system 102 may be distributed across server devices 104, client devices 108, or a combination of server devices 104 and client devices 108.

In the example of FIG. 1, a client device 108 may access a server device 104. The server devices 104 may represent generally any computing devices configured to respond to a network request received from the client device 108. A server device 104 may include a web server, an application server, or a data server. The client devices 108 may represent generally any computing devices configured with a browser or other application to communicate such requests and receive and/or process the corresponding responses. A link 106 may represent generally one or any combination of a cable, wireless, fiber optic, or remote connections via a telecommunications link, an infrared link, a radio frequency link, or any other connectors of systems that provide electronic communication. The link 106 may include, at least in part, intranet, the Internet, or a combination of both. The link 106 may also include intermediate proxies, routers, switches, load balancers, and the like.

Operation:

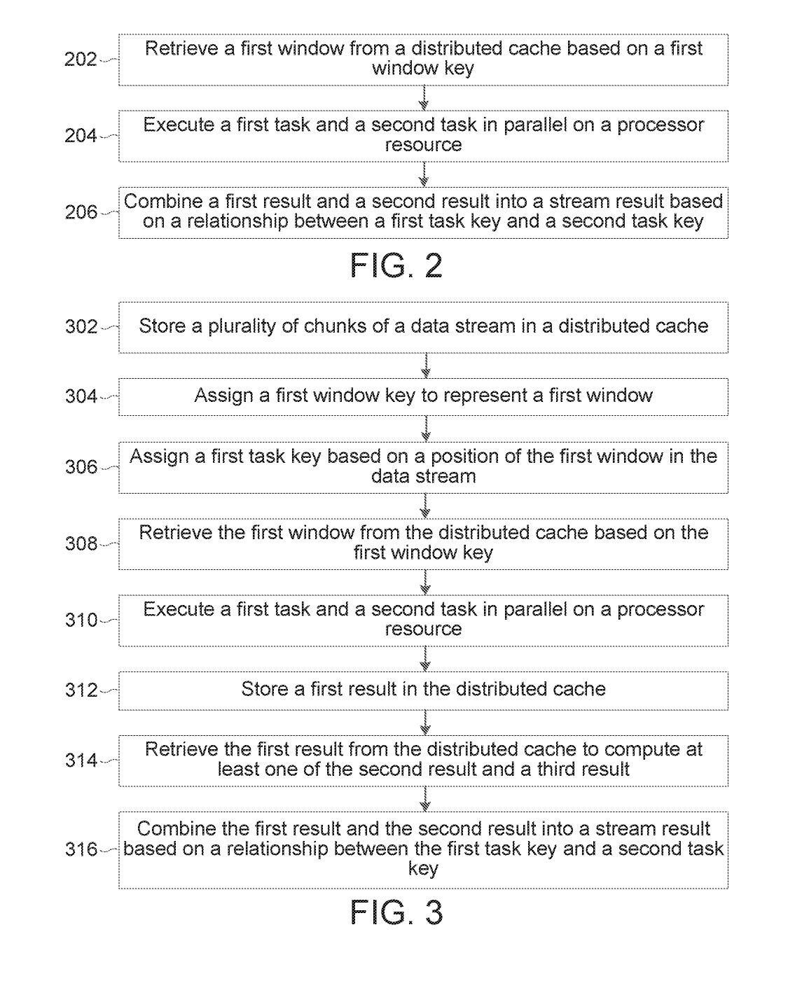

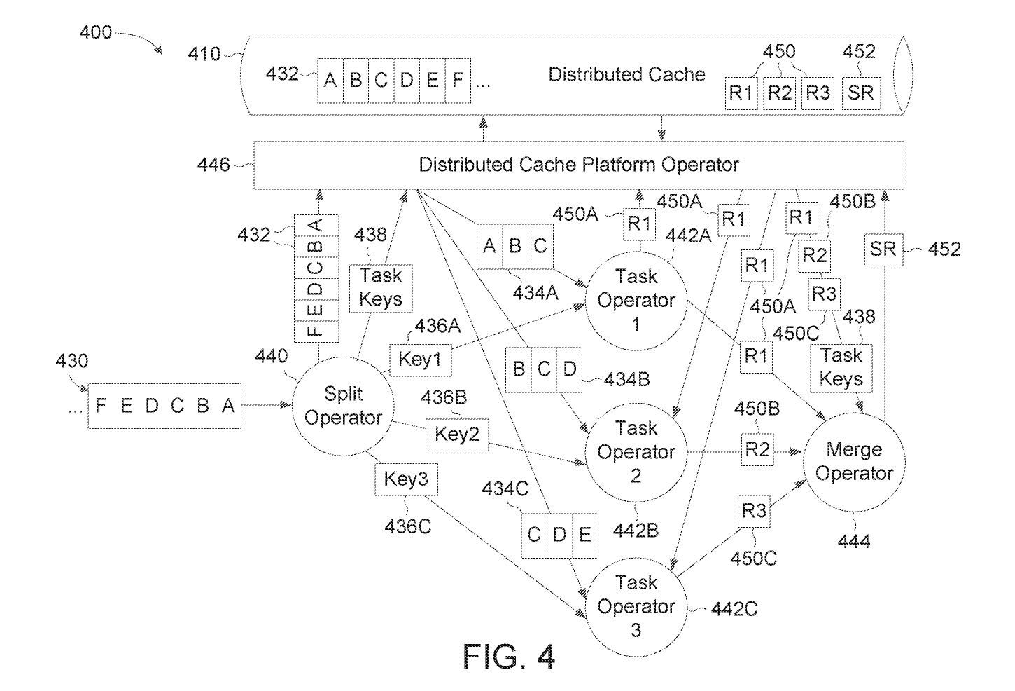

FIGS. 2 and 3 are flow diagrams depicting example methods for processing a data stream. In discussing FIGS. 2 and 3, reference may be made to elements and diagrams of FIGS. 4, 5, and/or 6 to provide contextual examples. Implementation, however, is not limited to those examples. The descriptions associated with FIGS. 4-6 include details applicable to the methods discussed in reference to FIGS. 3 and 4.

In block 202 of FIG. 2, a first window may be retrieved from a distributed cache, or a plurality of storage mediums, based on a first window key. The first window may be a portion of a set of data of a data stream. The data stream may be apportioned into a plurality of chunks by a split operation, discussed further in reference to FIGS. 3-6. The first window may comprise a first set of a plurality of chunks of the data stream. The first window may be identifiable by a first window key. The first window key may be an identifier capable of being used with a distributed cache platform for retrieval of data from a plurality of storage mediums. The distributed cache platform may be a protocol or other method to access the plurality of storage mediums as if the plurality of storage mediums is a single storage medium. For example, the distributed cache platform may use the window key to access a set of data contained in the plurality of storage mediums. The plurality of storage mediums may be represented and otherwise discussed herein as a distributed cache. Windows, chunks, distributed cache, and the distributed cache platform are discussed in more detail in reference to FIGS. 3-6.

A second window, or an additional window, may be retrieved from the distributed cache based on a second window key. The second window may include a second set of the plurality of chunks. The first set of the plurality of chunks and the second set of the plurality of chunks may include overlapping, or the same, chunks. For example in FIG. 2, the first window may include the chunks labeled “A,” “B,” and “C,” and the second window may include the chunks labeled “B,” “C,” and “D.”

In block 204, a first task and a second task may execute in parallel on a processor resource, such as a processor resource 622 of FIG. 6. The first task may produce a first result based on the first window and the second task may produce a second result based on the second window. The first task and the second task may perform an analysis operation on the first window and the second window respectively.

In block 206, a first result and a second result may be merged into a stream result based on a relationship between a first task key and a second task key. The first task key may be associated with the first task and the second task key may be associated with the second task. The results may be merged by combining, aggregating, adding, computing, summarizing, analyzing, or otherwise organizing the data. Analysis and summarization may be done on the individual results and/or the merged stream result. The task keys and merge operation are discussed in more detail in reference to FIGS. 3-6.

Referring to FIG. 3, the description of blocks 202, 204, and 206 may be applied to blocks 308, 310, and 316 respectively.

In block 302 of FIG. 3, a plurality of chunks of a data stream may be stored in a distributed cache. The data stream may be divided up into a plurality of chunks at the split operation to be associated with a window. Each one of the plurality of chunks may have a size based on a data characteristic. The data characteristic may be at least one of a time length, a bandwidth capacity, and a latency threshold. The data characteristic may comprise any other characteristic of the data usable to determine a chunk size.

In block 304, a first window key may be assigned to represent a first window. The first window key may be sent to a task to be used as input in performing an analysis operation. The first window key may be placed in a data structure associated window keys with windows. The split operation may punctuate or otherwise label each chunk to associate with a first window and may assign a window key based on that association. The window key or additional window keys may be assigned to represent additional windows respectively.

In block 306, a first task key may be assigned based on a position of the first window in the data stream. The first task key may be assigned based on the order of operations of the tasks being performed on the data stream, may be based on the position of the first window in the data stream, or otherwise may be assigned to maintain historical data in the analysis operations and/or merge of results. Additional task keys may be assigned respective of the amount of tasks performed and/or windows operated on. The additional task keys may be assigned based on a position of the additional windows in the data stream.

In block 308, the first window may be retrieved from the distributed cache based on the first window key. Additional windows may be retrieved based on the respective window key. A number of windows may be retrieved by the first window key, and/or additional window keys, based on a data characteristic, such as a latency threshold. The efficiency of the system may increase in relation to the number of windows retrieved per memory access request.

In block 310, a first task and a second task may execute in parallel. The first task and the second task may execute in parallel by a task engine or by a processor resource, such as the processor resource 622 of FIG. 6. Additional tasks may be executed in parallel or serially by the task engine or by the processor resource.

In block 312, a first result of the first task may be stored in the distributed cache. The first result may be available for access by other tasks and/or the merge engine.

In block 314, the first result may be retrieved from the distributed cache to compute at least one of the second result and a third result. Processing operations may be improved by providing results to the distributed cache platform for use in other operations.

In block 316, the first result and the second result may be merged into a stream result based on a relationship between a first task key and a second task key. The results of the task engine may be inputted to the distributed cache or may be sent to the merge operation directly. There may be a relationship among the task keys to define an order of the task keys. For example, the relationship between the first task key and the second task key may be historical. The task key order may be historical and/or otherwise history-sensitive or may be based on an analysis and/or summarization operation made on the result of the task. The stream result may be placed into the distributed cache for access by other operations.

FIG. 4 depicts example operations for processing a data stream 430. Referring to FIG. 4, the stream process system 400 may generally include a split operator 440, a task operator (such as the task operator 442A), a merge operator 444, and a distributed cache platform operator 446.

The distributed cache platform operator 446 may be operatively coupled to a distributed cache 410. The distributed cache platform operator 446 may perform operations of the distributed cache platform, which may be a protocol, or other method, to access the distributed cache 410. For example, the distributed cache platform may use a key, such as a window key described herein, to access a set of data contained in the distributed cache 410. The operations of the distributed cache platform, including window keys, are discussed in more detail in reference to FIGS. 2, 3, 5, and 6. In particular, the operations of the distributed cache platform operator 446 may be described in more detail in the description of the distributed cache platform engine 502 of FIG. 5. The distributed cache 410 may generally contain a plurality of storage mediums. The distributed cache 410 is discussed in more detail in reference to FIGS. 5 and 6.

The data stream 430 may be received by the split operator 440. The data stream 430 may include a set of data capable of being divided into data chunks, such as chunks 432, and windows, such as windows 434A, 434B, and 434C. A data chunk may represent a portion of a set of data of the data stream 430. For example in FIG. 4, the data chunks 432 are represented with letters A through F. A window may represent a plurality of data chunks. For example in FIG. 2, the window 234A may include chunks 232 labeled “A,” “B,” and “C.” The data stream 430 may be received in any appropriate sequence and the split operation may reorder the data when placing the chunks into the distributed cache 410. For example in FIG. 4, the data stream 430 is received and stored in the distributed cache 410 on a first-come, first-served basis. The split operator 440 may determine the chunk size and window size. Chunk size and window size determinations are discussed in more detail in reference to FIGS. 2, 3, 5, and 6.

The split operator 440 may input the data chunks to the distributed cache 410 using the distributed cache platform operator 446. The split operator 440 may send each chunk of the data stream 430 to the distributed cache 410. The split operator 440 may avoid sending the chunk directly to a task operator processing a window containing that chunk.

The split operator 440 or the distributed cache platform operator 446 may assign, or otherwise associate, a window key with a window. For example in FIG. 4, the window key 436A labeled “Key1” may represent the combination of data chunks 432 labeled as “A,” “B,” and “C.” The split operator 440 may send the window key associated with the window to a task operator. For example, the split operator 440 may send the window key 436A associated with the window 434A to task operator 442A. The split operator 440 may also send the window key to the distributed cache platform operator 446. The split operator 440 may distribute additional window keys to additional instances of the task operator directly or via the distributed cache platform operator 446. The split operator 440 may also assign, or otherwise associate, a task key 438 to the window or operation performed by the task operator 442. The task key 438 may be passed to the distributed cache platform operator 446 and stored in the distributed cache 410 as shown in FIG. 4. The task key(s) 438 may be retrieved and/or used by the merge operator 444, as described below. The task key 438 may be a separate data reference or may be the same key as the window key. Information associated with the order of the task keys 438 may be stored in the distributed cache 410 with the task keys 438. A task key may be assigned to each task and the order of the task key(s) may be used by the merge operator 444 to merge the results, discussed below. The task key and task key order are discussed in more detail in reference to FIGS. 2, 3, 5, and 6. The operations of the split operator 440 may be described in more detail in the description of the split engine 508 of FIG. 5.

A task operator may receive a window key and use the window key to retrieve the window associated with the window key from the distributed cache 410. For example in FIG. 4, the task operator 442B may retrieve the window 434B including data chunks 432 labeled “B,” “C,” and “D” by requesting data from the distributed cache platform operator 446 using the window key 434B labeled “Key2.” The task operator may perform a task, or operation, on the window. Each task of the task operator (or each instance of the task operator) may retrieve a window from the distributed cache 410 using a window key. The distributed cache 410 may be unified or otherwise commonly accessible to allow retrieval of an additional window or an additional data chunk from the cached data stream by a second task.

The task operator may perform an analysis operation on the window 234 retrieved using the window key. The task operator may perform an analysis operation on a second window or additional window retrieved using a second or additional window key. The task operator, or instances of the task operator, may execute tasks in parallel and otherwise perform analysis operations concurrently or in partial concurrence. Because a distributed cache platform is used, each task operator may share the chunks of the data stream 430 without duplication of data among tasks performed by the task operator. The task operator may request the data using a window key as a reference to the window of the cached data stream 430 and allow access to an overlapping chunk of the data stream 430 to multiple processing tasks being performed in parallel. For example in FIG. 4, the chunk 232 labeled “B” may be accessed in parallel to perform operations on the windows 434A and 434B associated with the window keys 436A and 436B labeled “Key1” and “Key2” respectively.

The analysis operation on the window may provide a result, such as a pattern. For example, the task operator 442A may produce a result 450A labeled “R1.” The task operator may send the result to the distributed cache platform operator 446 and/or the merge operator 444. For example in FIG. 4, the task operator 442A may input the result 450A labeled “R1” to the distributed cache platform operator 446 and/or send the result 450A to the merge operator 444.

The task operator may retrieve a previous result from the distributed cache platform operator 446 to use with the analysis operation. For example in FIG. 4, the task operator 442B may retrieve the result 450A labeled “R1” representing the result of the task operator 442A and use that pattern in the analysis operation the task operator 442B; the result 250A may concurrently, or in partial concurrence, be used by the task operator 442C. The results of the tasks performed by the task operator(s) may be encoded or otherwise represent a task key 238. For example, the block labeled “R1” may represent both a result 250A of the task and a task key 238. The operations of the task operator may be described in more detail in the description of the task engine 504 of FIG. 5.

The merge operator 444 may receive a result of the task operator and may merge the result with other results to form a stream result 452. The merge operator 444 may combine, analyze, summarize, or otherwise merge the results. For example in FIG. 4, the merge operator 444 may receive the results of the task operator(s), which may include results 450A labeled “R1,” 450B labeled “R2,” and 450C labeled “R3” and merge them into a stream result 452 labeled “SR” The results may be merged based on a task key 238 and/or a task key order. For example, the results 250A, 250B, and 250C, labeled “R1,” “R2,” and “R3” respectively, may be combined in numerical order based on the task key 238, where the task key 238 may be represented by or encoded in the results 250A, 250B, 250C, and/or in the window keys 236A, 236B, and 236C. The task key order may represent the position of the windows in the data stream 430 or another representation to maintain the history of the data when analyzing or otherwise merging the results. The task key order is discussed in more detail in reference to FIGS. 2, 3, 5 and 6. The merge operator 444 may input the stream result 452 to the distributed cache platform operator 446. The merge operator 444 may analyze the results individually or as a stream result 452. The operations of the merge operator 444 may be described in more detail in the description of the merge engine 506 of FIG. 5.

In general, the operators 440, 442, 444, and 446 of FIG. 4 described above represent operations, processes, interactions, or other actions performed by or in connection with the engines 502, 504, 506, and 508 of FIG. 5.

Components:

FIGS. 5 and 6 depict examples of physical and logical components for implementing various examples. FIG. 5 depicts an example of the stream process system 500 that may generally include a distributed cache 510, a distributed cache platform engine 502, a task engine 504, and a merge engine 506. The example stream process system 500 may also include a split engine 508. The distributed cache 510 may be the same as the distributed cache 410 of FIG. 4 and the description associated with the distributed cache 410 may be applied to the distributed cache 510, and vice versa, as appropriate.

The split engine 508 may represent any combination of hardware and programming configured to organize a set of data of a data stream into a plurality of windows and manage the task order of a plurality of tasks to perform analysis operations on the data stream. The split engine 508 may divide the set of data of the data stream into chunks and windows. The window may constitute a portion of the set of data of the data stream represented by a set of chunks. Sequential windows may generally contain overlapping chunks of data. For example, a sliding window technique may compute a first analysis by processing a first set of data including chunks 1 through 5, a second analysis by processing a second set of data including chunks 2 through 6, and a third analysis by processing a third set of data including chunks 3 through 7. In that example, chunks 3, 4, and 5 are overlapping chunks, or chunks used in each of the three analysis operations.

The split engine 508 may split the data into a window based on a data characteristic, such as the processability of the set of data. For example, the split engine 508 may split the data into windows that are processable by a task. The split engine 508 may be window-aware and may determine which set of data, such as a chunk and/or tuple, may be in the same partition and route the data to the appropriate node by associating the chunk, and its complementary chunks, with a window key.

The split engine 508 may be configured to assign a window key. The window key may be an identifier capable of representing a window. The split engine 508 may assign window keys sequentially, based on a data characteristic, or randomly. For example, the split engine 508 may separate the windows by using references such as “key1, key2, key3 . . . keyN.” The key may be more descriptive, such as “StreamA_5min, StreamA_10min . . . StreamA_Nmin.” The split engine 508 may send multiple window keys to the task.

The split engine 508 may assign a window, send the window key to the task engine 504, and request the task engine 504 perform an operation based on a window key. The split engine 508 may send a window key to a task instead of actual data of the data stream. The window key may allow for the window to be accessed from the distributed cache 510 by retrieving a window from the distributed cache platform engine 502 based on a window key and process the window using an analysis operation. Data may be retrieved from the distributed cache 510 at each task and avoid copying data by the split operation.

A window key may be assigned to associate with an additional window or a plurality of windows. For example, the first window key may represent a number of windows and the task engine 504 or a processor resource, such as processor resource 622 of FIG. 6, may retrieve the number of windows based on the first window key. The number of windows may be based on a data characteristic, such as latency threshold. Batch processing, or processing multiple windows per window key, may improve processing performance by reducing access time and data retrieval requests.

The split engine 508 may assign a plurality of window keys respective of the windows of the set of data of the data stream. The assignment of window keys may be made based on characteristics of the data stream. For example, the split engine 508 may assign the first window key based on a data characteristic, such as time length. A data characteristic may be at least one of a time length, a bandwidth capacity, and a latency threshold. The time length may be the amount of data broadcasted over a determined period of time. The bandwidth capacity may be the load capability of the processor resource and/or data connection, such as link 106 of FIG. 1. The latency threshold may be a minimum, a maximum, or a range of delay that is determined allowable for processing purposes. For example, the overall latency of the data retrieval may depend on the volume of data of each data retrieval performed by each task. Therefore, the size of a window may determine overall performance of processing the data stream. The stream process system 500 may determine the size of a window based on a data characteristic and may assign the window key accordingly. The size of the window may be determined based on a balancing between latency and task processing time because the window size may be directly related to overall latency and task processing time.

The split engine 508 may assign a task key. The task key may be an identifier to track result of an analysis operation and/or a window as the window is processed by a task. The split engine 508 may assign a task key to represent one of a plurality of tasks based on at least one of a position of a window in the data stream and an order of execution of the plurality of tasks. For example, the task key may track window operations based on window position or otherwise historical, as described below. For example, the split engine 508 may assign a first task key to a first task based on a position of a first window in the data stream. The task key may be used to organize, analyze, or otherwise merge a result of an analysis operation on a window. Merging the result based on task key may maintain history-sensitive context of the data stream analysis.

The split engine 508 may assign a plurality of task keys respective of the number of tasks performed by the split engine 508 associated with a data stream. The task keys may have an order or be associated with a table or other structure that may determine a task key order. Similar to assignments of window keys, the split engine 508 may assign task keys sequentially, based on a data characteristic, or randomly. For example, the split engine 508 may separate the tasks by using references such as “task1, task2, task3 . . . taskN,” or may include a descriptive reference, such as “window5min, window10min . . . windowNmin.” Randomized key assignments may use a table or other data structure to organize the keys.

The split engine 508 may at least one of assign a plurality of window keys and/or a plurality of task keys to maintain the historical state of the data stream. The split engine 508 may input a set of historical state data to the distributed cache platform engine 502 to be accessible by at least one of the task engine 504 and the merge engine 506. The task keys may be assigned to maintain the result order and/or analyze the results based on a history-sensitive operation. For example, the relationship between a first task key and the second task key may be historical. A historical relationship may be a relationship based on time of the data input, position of the window in the data stream, the time the task was performed, or other relationship that is sensitive to the history of data and/or processing operations. The system may merge the results to maintain the history of windows and/or the set of data by using a task key and/or each task key associated with the results to be merged.

The split engine 508 may input a window key and/or a task key to the distributed cache platform engine 502. The split engine 508 may input the chunks of the set of data to the distributed cache platform engine 502 where the chunks may be available to each one of the tasks performed by the task engine 504. Distribution of redundant data chunks of consecutive sliding windows to multiple computation operations may be avoided using a distributed cache platform.

The distributed cache 510 may include a plurality of storage mediums. The plurality of storage mediums may be cache, memory, or any storage medium described herein and may be represented as distributed cache 510. The distributed cache platform engine 502 may represent any combination of hardware and programming configured to maintain the distributed cache 510 and, in particular, to maintain a set of data of a data stream in the distributed cache 510. The distributed cache platform engine 502 may allow for the plurality of storage mediums to be accessed using a distributed cache platform. The distributed cache 510 may be a computer readable storage medium that is accessible by the distributed cache platform used by the distributed cache platform engine 502, distributed cache platform module 612, and/or the distributed cache platform operator 446, discussed herein. The distributed cache platform may be any combination of hardware and programming to provide an application programming interface (“API”) or other protocol that provides for access of data over a plurality of storage mediums or otherwise unifies storage mediums. For an example of using an API with the stream process systems described herein, “get(streamA_key1)” may return the data of the first window. The API may allow commands to be made locally, such as on a host or client computer, or remotely, such as over a cloud-based service accessible using a web browser and the Internet. An example open source distributed cache platform is MEMCACHED which provides a distributed memory caching system using a hash table across multiple machines. MEMCACHED uses a key-value based data caching and API.

The data stream may be inputted to the distributed cache platform engine 502 to be stored in the distributed cache 510. The data stream may be input, or stored, by chunks to the distributed cache platform engine 502. A copy of the data stream may be stored in the distributed cache 510 as the data stream is available, as the data stream is requested, chunk by chunk, or in varying sizes of portions of the data stream. For example, the split engine 508 may input the data stream into the distributed cache 510 chunk by chunk. The data stream copy may be stored in the distributed cache 510 all at once, at scheduled intervals, or at varying times. For example, the data stream may be stored in a batch or may be stored in multiple batches and/or storage requests.

The data stream may be divided into window sizes according to processing desires. For example, the distributed cache platform engine 502, or the split engine 508, may determine a chunk size and/or a window size and divide the set of data of the data stream into chunks. The size of the chunks may be based on at least one of a rate of the data stream input, a designated window size, a latency, or a processing batch size. The distributed cache platform engine 502 may label a chunk of the set of data to associate the chunk with a window. Punctuation, or labeling, may be based on a data characteristic. For example, punctuation based on the data characteristic of time length may use timestamps to determine which data chunks belongs to each window. Data stream punctuation may allow the system to recognize that a chunk of data is part of a window for processing. For example, a chunk may be marked with an identifier associated with a window to associate the chunk with a window key.

The distributed cache platform engine 502 may retrieve a window, or a portion of the set of data of the data stream, from the distributed cache 510 based on a window key. The window key may be a name, a label, a number, or other identifier capable of referring to a window and/or location in the distributed cache 510. The window key may represent the window according to a distributed cache platform. For example, the window key may be a name or label associated with the window such that the distributed cache platform may recognize that the window key may refer to a set of data in the distributed cache 510. The data contained in the distributed cache 510 may be accessible by each stream processing task via the distributed cache platform engine 502. For example, the data stream may be accessible by tasks performed by the stream process system 500 after the data stream is copied into the distributed cache 510 via the distributed cache platform engine 502.

The distributed cache 510 may be a unified plurality of storage mediums or otherwise accessible as one medium using a distributed cache platform. The distributed cache platform may utilize a window key to access the data, and the function requesting and/or utilizing the data may not know which particular storage medium contains the data. The distributed cache platform may allow for data stored within the distributed cache 510 to be accessed by reference. For example in the stream context, each chunk of data may be transferred once to the distributed cache 510, and may be referenced to during a task using a window key rather than transferring a copy of the data of the window and/or the chunk for each task. A distributed cache platform engine 502 may reduce and/or offload the operations of a split operation of a split-and-merge theme.

The task engine 504 may represent any combination of hardware and programming configured to process a window based on a window key. The task engine 504 may perform the tasks according to an operation, such as a pattern analysis operation, using a window of data as input. For example, the first task may produce a first result based on the first window and the second task may produce a second result based on a second window, where both windows may include an individualized set of the plurality of chunks, and the results may be associated with a possible pattern. Pattern analysis may include sequential pattern analysis. Pattern analysis may be performed by the task engine 504 using operations consistent with at least one of a categorical sequence labeling method, a classification method, a clustering method, an ensemble learning method, an arbitrarily-structured label prediction method, a multi-linear subspace learning method, a parsing method, a real-valued sequence labeling method, a regression method, and the like.

Each one of the plurality of tasks may compute a result from the analysis operation. For example, one of the plurality of tasks may compute a result associated with the first window and the result may be a pattern discovered by the analysis operation. The plurality of tasks may get a window of the data stream from the distributed cache 510 by using a window key associated with that window. For example, one of the plurality of tasks may process a first window based on a first window key. The task engine 504 may receive the window key from the split engine 508 and may request the window from the distributed cache platform engine 502.

The task engine 504 may be configured to execute tasks in parallel. For example, the task engine 504 may execute a first task and a second task in parallel. The task engine 504 may execute tasks on a processor resource, such as processor resource 622 of FIG. 6. The task engine 504 may execute a plurality of tasks, or computation operations, in parallel on the processor resource.

The task engine 504 may also receive task keys from the split engine 508. Alternatively, the task engine 504 may provide task keys to the distributed cache platform engine 502 for access and/or use by the task engine 504 and/or merge engine 506, discussed below.

A task may request a window or a batch of windows from the distributed cache platform engine 502 using a window key. For example, a first window key may be associated with a first window and a second window. A task operation may include an analysis operation and may produce a result associated with a window. The task operation may process additional windows and produce additional results.

The task engine 504 may provide access to the results of each task. For example, the task engine 504 may store a first result to the distributed cache platform engine 502 for access by a second task. A task result may be useful for future task operations. For example, the first result may be a discovered pattern in the data stream and may be used in following operations to compare to other windows. The task engine 504 may execute a second task, retrieve the first result from the distributed cache platform engine 502, and compute a second result based on the first result. The task engine 504 may produce a plurality of results where the first result may be one of the plurality of results and the second result may be another one of the plurality of results.

The task engine 504 may distribute tasks across a processor resource, such as processor resource 622 of FIG. 6. For example, a processor resource may include multiple processors and/or multiple machines that may be coupled directly or across a link, such as link 106 of FIG. 1. The task engine 504 may distribute a task based on a partition criterion. For example, the task engine 504 may distribute a task to a first processor of a processor resource based on at least one of a shuffle partition criterion and a hash partition criterion.

The merge engine 506 may represent any combination of hardware and programming configured to merge a result of the task engine 504 based on a task key. The merge engine 506 may be configured to combine, summarize, analyze, and/or otherwise merge the results of the operations of the task engine 504. For example, the merge engine 506 may merge the first result and second result into a stream result based on a first task key and a second task key, where the first task key may be associated with a first task and the second task key may be associated with a second task. For example, the merge engine 506 may merge a result into a stream result based on a task order. For another example, the merge engine 506 may merge each of a plurality of results into a stream result based on a task order. The merge engine 506 may receive a result from each one of the tasks performed by the task engine 504. The merge engine 506 may combine, summarize, analyze, and/or otherwise merge the result, the plurality of results, and/or the set of data of the data stream. The merge engine 506 may retrieve the task keys from the distributed cache platform engine 502 or receive the task keys from the task engine 504 or the split engine 508, discussed below.

FIG. 6 depicts the stream process system 600 may be implemented on a memory resource 620 operatively coupled to a processor resource 622. The processor resource 622 may be operatively coupled to the distributed cache 610. The distributed cache 610 may be the same as the distributed cache 410 of FIG. 4 and/or the distributed cache 510 of FIG. 5 and the description associated with the distributed cache 410 and distributed cache 510 may be applied to the distributed cache 610, and vice versa, as appropriate.

In the example of FIG. 6, the memory resource 620 may contain a set of instructions to be carried out by the processor resource 622. The executable program instructions stored on the memory resource 620 may be represented as the distributed cache platform module 612, the task module 614, the merge module 616, and the split module 618 that when executed by the processor resource 622 may implement the stream process system 600. The processor resource 622 may carry out the set of instructions to execute the distributed cache platform module 612, the task module 614, the merge module 616, the split module 618, and/or any operations between or otherwise associated with the modules of the stream process system 600. For example, processor resource 622 may carry out a set of instructions to retrieve a window from the distributed cache platform engine 502 based on a window key, cause the task engine 504 to execute a plurality of tasks in parallel, and send a result of a task to the merge engine to merge the result into a stream result based on a task order. The distributed cache platform module 612 may represent program instructions that when executed function as a distributed cache platform engine 502. The task module 614 may represent program instructions that when executed function as a task engine 504. The merge module 616 may represent program instructions that when executed may function as a merge engine 506. The split module 618 may represent program instructions that when executed function as a split engine 508. The engines 502, 504, 506, and 508 and/or the modules 612, 614, 616, and 618 may be distributed across any combination of server devices, client devices, and storage mediums. The engines 502, 504, 506, and 508 and/or the modules 612, 614, 616, and 618 may complete or assist completion of operations performed in describing another engine 502, 504, 506, and 508 and/or the module 612, 614, 616, and 618.

The processor resource 622 may be one or multiple central processing units (“CPU”) capable of retrieving instructions from the memory resource 620 and executing those instructions. The processor resource 622 may process the instructions serially, concurrently, or in partial concurrence, unless described otherwise herein.

The memory resource 620 and the distributed cache 610 may represent a medium to store data utilized by the stream process system 600. The medium may be any non-transitory medium or combination of non-transitory mediums able to electronically store data and/or capable of storing the modules of the stream process system 600 and/or data used by the steam process system 600. The medium may be machine-readable, such as computer-readable. The data of the distributed cache 610 may include representations of a data stream, a window key, a task key, a result and/or other data mentioned herein.

In the discussion herein, engines 502, 504, 506, and 508 and modules 612, 614, 616, and 618 have been described as combinations of hardware and programming. Such components may be implemented in a number of fashions. Looking at FIG. 6, the programming may be processor executable instructions stored on the memory resource 620, which is a tangible, non-transitory computer readable storage medium, and the hardware may include processor resource 622 for executing those instructions. The processor resource 622, for example, may include one or multiple processors. Such multiple processors may be integrated in a single device or distributed across devices. For example, the processor resource 622 may be distributed across any combination of server devices and client devices. The memory resource 620 may be said to store program instructions that when executed by processor resource 622 implements the stream process system 600 in FIG. 6. The memory resource 620 may be integrated in the same device as processor resource 622 or it may be separate but accessible to that device and processor resource 622. The memory resource 620 may be distributed across devices. The memory resource 620 and the distributed cache 610 may represent the same physical medium unless otherwise described above.

In one example, the program instructions can be part of an installation package that when installed may be executed by processor resource 622 to implement the system 600. In this case, memory resource 620 may be a portable medium such as a CD, DVD, or flash drive or memory maintained by a server from which the installation package may be downloaded and installed. In another example, the program instructions may be part of an application or applications already installed. Here, the memory resource 620 may include integrated memory such as a hard drive, solid state drive, or the like.

### CONCLUSION

FIGS. 1-6 depict architecture, functionality, and operation of various examples. In particular, FIGS. 5 and 6 depict various physical and logical components. Various components are defined at least in part as programs or programming. Each such component, portion thereof, or various combinations thereof may represent in whole or in part a module segment or portion of code that comprises an executable instruction that may implement any specified logical function(s) independently or in conjunction with additional executable instructions. Each component or various combinations thereof may represent a circuit or a number of interconnected circuits to implement the specified logical function(s).

Examples can be realized in any computer-readable medium for use by or in connection with an instruction execution system such as a computer/processor based system or an Application Specific Integrated Circuit (“ASIC”) or other system that can fetch or obtain the logic from the computer-readable medium and execute the instructions contained therein. “Computer-readable medium” may be any individual medium or distinct media that may contain, store, or maintain a set of instructions and data for use by or in connection with the instruction execution system. A computer readable storage medium may comprise any one or combination of many physical, non-transitory media such as, for example, electronic, magnetic, optical, electromagnetic, or semiconductor media. Specific examples of computer-readable medium may include, but are not limited to, a portable magnetic computer diskette such as hard drives, solid state drives, random access memory (“RAM”), read-only memory (“ROM”), erasable programmable ROM, flash drives, and portable compact discs.

Although the flow diagrams of FIGS. 2 and 3 illustrate specific orders of execution, the order of execution may differ from that which is illustrated. For example, the order of execution of the blocks may be scrambled relative to the order shown. Also, the blocks shown in succession may be executed concurrently or with partial concurrence. All such variations are within the scope of the present invention.

The present description has been shown and described with reference to the foregoing examples. It is understood, however, that other forms, details, and examples may be made without departing from the spirit and scope of the invention that is defined in the following claims.

What is claimed is:

1. A method for processing a data stream comprising:
retrieving a first window from a distributed cache based on a first window key, the first window comprising a first set of a plurality of chunks of the data stream;
executing a first task and a second task in parallel on a processor resource, the first task to produce a first result based on the first window and the second task to produce a second result based on a second window; and
merging the first result and the second result into a stream result based on a relationship between a first task key and a second task key, the first task key associated with the first task and the second task key associated with the second task.

2. The method of claim 1, comprising:
assigning the first window key to represent the first window; and
assigning the second window key to represent the second window.

3. The method of claim 1, comprising
assigning the first task key based on a position of the first window in the data stream; and
assigning the second task key based on a position of the second window in the data stream.

4. The method of claim 1, wherein the relationship between a first task key and the second task key is historical.

5. The method of claim 1, comprising storing the plurality of chunks of the data stream in the distributed cache, each one of the plurality of chunks having a size based on a data characteristic.

6. The method of claim 5, wherein the data characteristic is at least one of a time length, a bandwidth capacity, and a latency threshold.

7. The method of claim 1, comprising
storing the first result in the distributed cache; and
retrieving the first result from the distributed cache to compute at least one of the second result and a third result.

8. A computer readable storage medium having instructions stored thereon, the instructions including a distributed cache platform module, a task module, and a merge module, wherein:
the distributed cache platform module is executable by a processor resource to:
store a plurality of chunks of a data stream in a set of storage mediums; and
retrieve a first window from the set of storage mediums based on a first window key, the first window comprising a first set of the plurality of chunks;
the task module is executable by the processor resource to:
execute a first task and a second task in parallel on the processor resource, the first task to produce a first result based on the first window and the second task to produce a second result based on a second window, the second window comprising a second set of the plurality of chunks;
the merge module is executable by the processor resource to:
merge the first result and second result into a stream result based on a first task key associated with the first task and a second task key associated with the second task.

9. The computer readable storage medium of claim 8, wherein the instructions include a split module, wherein the split module is executable by the processor resource to:
assign the first window key based on a data characteristic; and
assign the first task key to the first task based on a position of the first window in the data stream.

10. The computer readable storage medium of claim 8, wherein the first window key represents a number of windows, the processor resource to retrieve the number of windows based on the first window key, the first window constituting one of the number of windows.

11. The computer readable storage medium of claim 8, wherein the number of windows is based on a latency threshold.

12. A system for processing a data stream comprising:
a distributed cache platform engine to maintain a set of data of the data stream in a set of storage mediums;
a task engine to process a window based on a window key, the window constituting a portion of the set of data;
a merge engine to merge a result of the task engine based on a task key; and
a processor resource operatively coupled to a computer readable storage medium, wherein the computer readable storage medium contains a set of instructions, the processor resource to carry out the set of instructions to:
retrieve the window from the distributed cache platform engine based on the window key;
cause the task engine to execute a plurality of tasks in parallel on the processor resource, one of the plurality of tasks to compute a result, one of the plurality of tasks to process the window based on the window key; and
send the result to the merge engine to merge the result into a stream result based on a task order.

13. The system of claim 12, further comprising a split engine to organize the set of data into a plurality of windows and manage the task order, the split engine to:
assign a window key to represent the window; and
assign the task key to represent the one of the plurality of tasks based on at least one of a position of the window in the data stream and an order of execution of the plurality of tasks.

14. The system of claim 12, wherein the set of instructions:
input the data stream to the distributed cache platform engine; and
label a chunk of the set of data to associate the chunk with the window.

15. The system of claim 12, wherein the set of instructions:
input a first result to the distributed cache platform engine;
retrieve the first result from the distributed cache platform engine; and
compute a second result based on the first result.
